(19) United States
(12) Patent Application Publication
(10) Pub. No.: US 2003/0007055 A1
(43) Pub. Date: Jan. 9, 2003

(54) Image-forming apparatus and method

(76) Inventor: Ayao Ogawa, Nagano-ken (JP)

Correspondence Address: HOGAN & HARTSON L.L.P., 500 S. GRAND AVENUE, SUITE 1900, LOS ANGELES, CA, 90071-2611, US

(21) Appl. No.: 10/174,500

(22) Filed: Jun. 17, 2002

(30) Foreign Application Priority Data
Jun. 27, 2001 (JP) 2001-194290

(51) Int. Cl. B41J 2/01

(52) U.S. Cl. 347/102; 347/103

(57) ABSTRACT

There is provided an image-forming apparatus and method which forcibly removes moisture of ink forming a printed image, thereby enhancing the quality of a transferred image formed by transferring the print image. A printer device prints an image on a transfer film, with a sublimable dye ink, by an ink jet printing method. A dryer device vaporizes moisture of the sublimable dye ink of a printed image formed on the transfer film. A thermal press carries out a thermal pressing process on the dried transfer film and the print medium overlaid with each other, to thereby diffuse and fix the sublimable dye ink held in the transfer film on a surface of the print medium.

### BACKGROUND OF THE INVENTION

1. Field of the Invention

This invention relates to an image-forming apparatus and method which forms an image by using a transfer medium on which an image is printed by sublimable dye ink and performing thermal transfer of the image to a print medium as an object medium of the thermal transfer.

2. Prior Art

Conventionally, an image-forming method is known which transfers from a transfer paper to a print medium an image printed on the transfer paper by using a sublimable dye ink by one of various printing methods. Among these methods, the image-forming apparatus and method based on an ink jet printing method ejects ink droplets to the transfer paper to cause the paper to be impregnated with the ink droplets, thereby causing the ink droplets to be held by the transfer paper, overlays the transfer paper on a surface of the print medium, and performs a thermal pressing process with a thermal press mechanism or the like to cause molecules of the ink droplets held by the transfer paper to migrate into the print medium via the printing surface in the direction of lamination, thereby dispersing and fixing the ink droplets on the print medium, whereby an image is formed on the print medium by transfer from the transfer paper.

In such an image-forming apparatus and method, when the operations from the printing to the thermal transfer under pressure are continuously carried out, the ink forming the image printed on the transfer paper is subjected to the thermal transfer before being dried (still containing lots of moisture). In such a case, the moisture of the ink is transformed into vapor bubbles when the ink is heated under pressure in the thermal pressing process, and the bubbles move into minute gaps or are trapped therein, so that the transferred image can develop bleeding or color variation. Further, the ink droplets ejected onto the transfer paper are apt to diffuse along the fibers of the paper so that the bleeding of the image tends to occur, which means that there is a problem of the quality of the image having already been spoiled before the thermal transfer of the image is carried out.

### SUMMARY OF THE INVENTION

It is an object of the invention to provide an image-forming apparatus and method which forcibly removes moisture of ink forming a printed image, thereby enhancing the quality of a transferred image formed by transfer of the print image.

To attain the above object, according to a first aspect of the invention, there is provided an image-forming apparatus comprising:

printing means for printing an image on a transfer film, with a sublimable dye ink, by an ink jet printing method;

drying means for vaporizing moisture of the sublimable dye ink of a printed image formed on the transfer film; and

fixing means for overlaying the dried transfer film and a print medium with each other, and carrying out a thermal pressing process on the dried transfer film and the print medium overlaid with each other, to thereby diffuse and fix the sublimable dye ink held in the transfer film on a surface of the print medium.

To attain the above object, according to a second aspect of the invention, there is provided an image-forming method comprising the steps of:

printing an image on a transfer film, with a sublimable dye ink, by an ink jet printing method;

vaporizing moisture of the sublimable dye ink of a printed image formed on the transfer film; and

overlaying the dried transfer film and a print medium with each other, and carrying out a thermal pressing process on the dried transfer film and the print medium overlaid with each other, to thereby diffuse and fix the sublimable dye ink held in the transfer film on a surface of the print medium.

According to this image-forming apparatus and method, when an image is printed on a transfer film, the sublimable dye ink is impregnated into the film and held thereby. Then, a print medium having the printed transfer film overlaid thereto with the printing surface (or surface opposite thereto) of the film on a surface of the print medium is subjected to a thermal pressing process, whereby particles of the sublimable dye ink at a molecular level are migrated deep into the print medium to develop color and be fixed therein to form a transferred image. Then, by removing the transfer film, the print medium is produced which has the image easily formed on the surface thereof.

In the above procedure of image forming, prior to the thermal pressing process, the transfer film in a humid state is forcedly dried to such an extent that the sublimable dye ink does not undergo the molecular migration to remove moisture of the ink. This makes it possible to perform the thermal pressing process on the transfer film in an adequately dried state. This reduces the amount of vaporized moisture to a very small degree to suppress generation of vapor bubbles, which prevents undesired color variation and color bleeding.

Further, since the transfer film is used as the transfer medium, ink droplets received thereby do not spread along the fibers, and therefore, the bleeding of the image printed thereon per se can be suitably prevented.

Preferably, the drying means comprises a heater for heating air into hot air, and a fan for blowing the hot air toward the transfer film.

According to this preferred embodiment, the transfer film in the humid state is dried by hot air. This makes it possible to rapidly vaporize the moisture of ink in a non-contacting manner.

More preferably, the image-forming apparatus includes a transport passage for feeding the transfer film thereon, the printing means and the drying means facing the transport passage, and a preheating plate arranged to face the transport passage at an intermediate location along the transport passage between the printing means and the drying means, for preheating the printed transfer film.

According to this preferred embodiment, the transfer film in the humid state is preheated to have its temperature raised and then brought to the drying means. This enables the drying means to perform the main drying process over a reduced time period. Further, the printing means and the drying means are arranged with a predetermined spacing therebetween due to provision of the preheating plate, and this makes it possible to properly prevent the ink jet head from being directly adversely affected by the hot air blown by the fan.

More preferably, the image-forming apparatus includes control means for controlling operation of the drying means, and the control means controls at least one of an amount of heat generated by the drying means and a quantity of the hot air blown by the drying means, based on an amount of ink for forming the printed image.

According to this preferred embodiment, the drying process can be carried out depending on the amount of ink forming the printed image, i.e. the amount of moisture of the ink. This makes it possible to dry the transfer film over a constant time period (short time period) irrespective of whether the amount of the ink is large or small, and thereby prevent the drying time from adversely affecting operations of the other devices.

Preferably, the image-forming apparatus includes film-feeding means for feeding the transfer film to bring the transfer film to the drying means, and control means for controlling operation of the film-feeding means, and the control means controls a feeding speed at which the film-feeding means feeds the transfer film, based on an amount of ink for forming the printed image.

According to this preferred embodiment, it is possible not only to control the time for the drying process depending on the amount of ink for forming the printed image, i.e. the amount of moisture of the ink but also to carry out the drying process continuously. This makes it possible to maintain the printed image at a proper quality level, and efficiently carry out the thermal pressing process subsequent thereto.

Preferably, the drying means comprises a heat plate for heating the transfer film placed horizontally thereon.

According to this preferred embodiment, the transfer film in the humid state is dried by heating on the heat plate. This makes it possible to vaporize the moisture of the ink rapidly in a contact state. Further, it is possible to perform a batch process with enhanced time efficiency, by collectively placing a plurality of printed transfer films on the heat plate.

More preferably, the image-forming apparatus includes control means for controlling operation of the drying means, and the control means controls an amount of heat generated by the drying means, based on an amount of ink for forming the printed image.

According to this preferred embodiment, it is possible to control the amount of heat generated for drying, depending on the amount of ink forming the printed image, i.e. the amount of moisture of the ink. This makes it possible to properly control the heating temperature and the heating time with finesse to maintain the printed image at a proper quality level, and thereby prevent the drying process from adversely affecting operations of the other devices, and efficiently carry out the thermal pressing process subsequent thereto.

Preferably, the image-forming apparatus further includes medium-reversing means for turning over the print medium on which the image has been fixed, and setting the print medium again on the fixing means.

According to this preferred embodiment, even if the print medium undergoes warpage due to a first operation of the thermal pressing process, it can be restored to its flat state by performing another operation of the same under the same conditions. This makes it possible to prevent spoiling of not only the image quality of the print medium but also commercial value thereof. Further, it is preferable that prior to the turn-over of the print medium, the print medium is forcedly cooled under pressure.

Preferably, the print medium is a card.

According to this preferred embodiment, it is possible to form a high-quality image on the card. For instance, even in the case of an image including a photograph as part thereof, such as a driver's certificate, it is possible to effectively prevent color variation and blur of the image.

Preferably, the transfer film has a flat surface formed of a water-soluble resin material, via which the transfer film is overlaid to the print medium.

According to this preferred embodiment, the transfer film is made of a water-soluble resin, and hence it is possible to properly prevent feathering, and make the ink absorptivity excellent in printing, whereby the ink can be stably impregnated and held within the transfer film without diffusing the ink. Therefore, in the thermal pressing process, the printed image is directly transferred to the surface of the print medium without permeating through the transfer film, which enables faithful transfer of the image. Further, on the surface of the print medium, the flat surface of the transfer film is overlaid, and hence the air trapped between the transfer film and the print medium is easily expelled therefrom, enabling the transfer film to be brought into as intimate contract as possible with the print medium. Therefore, it is possible to effectively prevent color variation of the transferred image which might be caused by microspace formed by rough surface contact.

The above and other objects, features, and advantages of the invention will become more apparent from the following detailed description taken in conjunction with the accompanying drawings.

### BRIEF DESCRIPTION OF THE DRAWINGS

FIG. 1 is a cross-sectional view schematically showing the arrangement of essential operational blocks of an image-forming apparatus according to a first embodiment of the invention;

FIG. 2A is a cross-sectional view of a structure of a transfer film for use in the FIG. 1 image-forming apparatus;

FIG. 2B is a cross-sectional view of a structure of an inexpensive print medium for use in the FIG. 1 image-forming apparatus;

FIG. 2C is a cross-sectional view of a structure of a high-grade print medium for use in the FIG. 1 image-forming apparatus;

FIGS. 3A to 3E are cross-sectional views of the transfer film and a print medium, schematically illustrating a procedure of printing an image on the transfer film and transferring the image from the transfer film to the print medium to form the image on the print medium;

FIG. 4 is a cross-sectional view of a transfer block of an image-forming apparatus according to a second embodiment of the invention;

FIG. 5A is a cross-sectional view of a transfer block of an image-forming apparatus according to a third embodiment of the invention;

FIG. 5B is a cross-sectional view of a variation of the transfer block of the image-forming apparatus according to the third embodiment;

FIG. 6 is a cross-sectional view of a printer block of an image-forming apparatus according to a fourth embodiment of the invention;

FIG. 7A is a cross-sectional view of a printer block of an image-forming apparatus according to a fifth embodiment of the invention;

FIG. 7B is a cross-sectional view of a heat plate of the image-forming apparatus according to the fifth embodiment; and

FIG. 7C is a plan view of the heat plate.

### DETAILED DESCRIPTION OF PREFERRED EMBODIMENTS

The invention will now be described in detail with reference to drawings showing preferred embodiments thereof. An image-forming apparatus according to a first embodiment of the present invention performs thermal transfer of desired images from a water-soluble transfer film onto a print medium in the form of a resin card. More specifically, the apparatus prints an image e.g. of characters, figures, a background, and/or the like, on the transfer film with sublimable dye ink by the ink jet printing method, and then overlays the transfer film on the print medium after forcibly drying the printed image, followed by thermally transferring the printed image from the transfer film to the print medium to form a high-quality transfer image on the print medium.

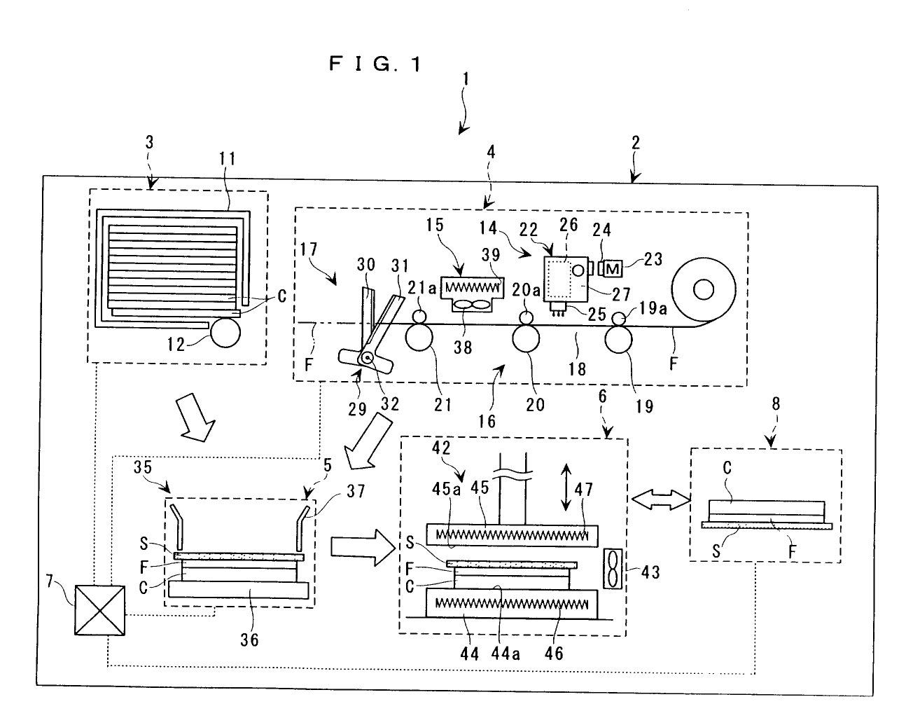

Referring first to FIG. 1, there are schematically shown essential operational blocks forming the internal structure of the image-forming apparatus. The essential operational blocks of the image-forming apparatus 1 arranged within an apparatus body 2 including an outer shell formed by a box-shaped casing, include a medium feeder block 3 for feeding a print medium C, a printer block 4 for feeding a transfer film F and printing an image on the same, an overlay block 5 for overlying the printed transfer film F and the print medium C to each other, and a transfer block 6 for carrying out thermal transfer of the printed image from the transfer film F to the print medium C overlaid therewith. Further, the image-forming apparatus 1 includes a controller 7 for controlling the overall operations of the essential blocks. Within the apparatus body 2, there is also arranged carrier means that links the above-mentioned essential operational blocks with each other and carries the transfer film F and the print medium C from one block to another.

The medium feeder block 3 is comprised of a media cassette 11 containing a plurality of print media C in a stacked manner, and a feed roller 12 arranged under a lower front portion of the media cassette 11 as a driving roller. The media cassette 11 has an inner plane shape generally similar to the plane shape of the print medium C. Further, the media cassette 11 has a predetermined depth which allows a plurality of print media C to be set in a stacked manner. The feed roller 12 is positioned in a manner held in rolling contact with a forward portion of the underside surface of a lowermost one of the stacked print media C, so as to ensure one-by-one feed of print media C to the overlay block 5.

The printer block 4 is comprised of a printer device 14 which carries out printing on the transfer film F unwound from its roll, a dryer device 15 which forcibly dries the printed transfer film F by hot air, carrier roller means 16 which advances the transfer film F along a transport passage 18 such that the transfer film E is brought to the printer device 14 and the dryer device 15, and a cutter device 17 which cuts off the printed portion of the transfer film F advanced by the carrier roller means 16. The transfer film F unwound from its roll by the carrier roller means 16 is advanced to a position facing the printer device 14, where a desired image is printed on the transfer film F, then to a position (drying position) facing the dryer device 15, where the printed portion of the transfer film F is dried, and further advanced to a position facing the cutter device 17, which cuts off the printed portion into a transfer film (strip) F in the form of a label.

The carrier roller means 16 is comprised of a feed roller 19 for unwinding the transfer film F and bringing the same to the printing position where printing is carried out by the printer device 14, a intermediate feed roller 20 for sending the transfer film F received from the feed roller 19 to the drying position, a delivery roller 21 for delivering the transfer film F received from the intermediate feed roller 20 to the cutter device 17, a drive motor, not shown, as a drive source for the rollers 19, 20, 21 and a driving force-transmitting mechanism e.g. comprised of gears, not shown, for transmitting torque of the drive motor to these rollers 19, 20, 21.

The feed roller 19, the intermediate feed roller 20, and the delivery roller 21 are each formed by a so-called grip roller, and cooperate with respective associated rollers 19a, 20a, 21a to sandwich the transfer film and advance the same by rotation thereof. The feed roller 19 is arranged at a location upstream of the printer device 14 in a direction of feeding of the transfer film F; the intermediate feed roller 20 is arranged at a location downstream of the printer device and upstream of the dryer device 15; and the delivery roller 21 is arranged at a location downstream of the dryer device 15.

The printer device 14 is comprised of a head unit 22, a carriage motor 23 as a drive source, and a reciprocating mechanism 24 which receives torque from the carriage motor 23 to reciprocate the head unit 22. The head unit 22 is comprised of an ink jet head 25 having a plurality of nozzles formed in an underside surface thereof, an ink cartridge 26 which supplies sublimable dye ink to the ink jet head 25, and a carriage 27 carrying the ink jet head 25 and the ink cartridge 26. The ink cartridge 26 contains four colors (yellow (Y), cyan (C), magenta (M), and black (B)) of sublimable dye ink. Alternatively, it may contain six colors of sublimable dye ink, i.e. the above four colors plus two colors (light cyan (LM) and light magenta (LM) of ink.

When the reciprocating mechanism 24 causes the carriage 27 to reciprocate, ink droplets are ejected, as required, from the ink jet head 25, whereby printing is effected on the transfer film F. More specifically, while the transfer film F is fed or advanced intermittently to pass under the head unit 22, the head unit reciprocates in a direction orthogonal to the feeding direction to carry out printing on the transfer film F. That is, printing operation is performed by the ink jet method using the sublimable dye ink such that the reciprocating motion of the head unit 22 and the feed of the transfer film F serve as the main scanning and the sub scanning in printing technology, respectively.

The sublimable dye ink is an ink comprised of a sublimable dye material and sublimed by heat. As described in detail hereinafter, in the printing process, the sublimable dye ink is impregnated into the transfer film F and temporarily held in the same. Then, the sublimable dye ink is transferred to the print medium C by heat generated in heat treatment for thermal transfer, and diffused/evaporated in the print medium C to develop color.

The dryer device 15 is arranged downstream of the printer device 14, and formed by a dryer which faces the transfer film sent thereto in a non-contacting manner. The dryer 15 is comprised of a fan 38 for blowing air toward the transport passage 18, and a nichrome wire heater 39 for heating the air blown by the fan 38. The dryer 15 faces the transfer film F with a predetermined distance therefrom, and blows the air to the printed image to dry the same. That is, the transfer film F has its humid printed image exposed to the hot air to be thereby forcedly dried, and after thus having the moisture of ink of the printed image vaporized, sent forward to the cutter device 17. It should be noted that the forced drying of the transfer film F can be controlled by factors consisting of a quantity of air blown and an amount of heat generated by the nichrome wire heater 39, and a factor consisting of feeding speed of the transfer film F, as described in detail hereinafter. Further, the casing, not shown, is preferably formed with an air inlet port and an air outlet port which open into a passage of air stream generated by the fan.

The cutter device 17 is arranged at a location downstream of the printer device 14 in a manner facing the transport passage 18. The cutter device 17 is comprised of a scissors-type cutter 29 formed by coupling a fixed blade 30 and a movable blade 31 by a pivot 32 such that the movable blade 30 can pivotally move about the pivot 32, and a cutter-driving mechanism, not shown, for driving the cutter 29 by the movable blade 31 for cutting operation. The fixed blade 30 and the movable blade 31 are positioned in a manner opposed with each other via the transport passage 18 therebetween, and when the cutter-driving mechanism operates, the movable blade 31 pivotally moves to the fixed blade 30 to cut through the transfer film F by sandwiching the same between the fixed blade 30 and itself. In short, the printed portion of the transfer film F fed or advanced by the delivery roller 21 is cut off into a label-shaped transfer film (strip) F by the pivotal movement of the movable blade 31 and delivered to the overlay block 5.

The overlay block 5 includes an overlay mechanism 35 which overlays the printed transfer film (strip) F to the print medium C, and overlays a cushion sheet S to the transfer film F. The overlay mechanism 35 is comprised of a table 36 also serving as a tray, a feed guide 37 for guiding the print medium C and the transfer film F onto the table 36, and a cushion-introducing device, not shown, for placing the cushion sheet S on the transfer film F.

The feed guide 37 has the shape of a hollow rectangular prism having an inner shape adapted to the plane shapes of the print medium C and the transfer film F. Further, the feed guide 37 has a top portion thereof expanded outward. The print medium C fed from the medium feeder block 3 is thrown into the feed guide 37 from above and then guided by the same to be placed on the table 36 in a positioned state. Similarly, the transfer film F introduced from the printer block 4 is thrown into the feed guide 37, with its printing surface directed downward, and then guided by the same to be placed (overlaid) on the print medium C in a positioned state.

The cushion-introducing device, not shown specifically, is similar in construction to the medium feeder block 3 and comprised of a cushion stocker containing a large number of cushion sheets S in a stacked manner and a sheet-feeding roller for feeding the cushion sheets S one by one from the cushion stocker. A cushion sheet S is introduced into the overlay mechanism 35 in a manner inserted horizontally through a gap between the transfer film F already introduced onto the table 36 and the lower end of the feed guide 37. It should be noted that the cushion sheet S is preferably formed of a heat-resistant and soft material, such as silicone, urethane, or vinyl chloride.

Thus, the print medium C and the transfer film F are overlaid to each other such that the print medium C is aligned on and brought into intimate contact with a print image portion of the transfer film F with the printed image formed by the sublimable dye ink held in the printing surface thereof, and further the cushion sheet S is overlaid to a surface (i.e. surface opposite to the printing surface) of the transfer film F in a manner covering the same. The non-printing surface of the transfer film F may be overlaid to i.e. placed on the print medium C. Then, the print medium C, the transfer film F and the cushion sheet S overlaid as above are carried to the transfer block 6 together with the table 36, where they are moved from the table 36 to the transfer block 6.

When it is required to transfer and form print images on the both surfaces of the print medium C, respectively, the printing, drying and cutting operations are each carried out twice to thereby prepare two transfer film strips F. Then, in the overlay block 5, the transfer film strips F are overlaid to the respective front and back surfaces of the print medium C in a manner such that the printing surfaces of the transfer film strips F face the respective surfaces of the print medium C, followed by cushion sheets S being laminated on the respective transfer film strips F overlaid to the print medium C. In short, one cushion sheet S, one transfer film F, the print medium C, the other transfer film F and the other cushion sheet S are overlaid to each other (i.e. thrown into the overlay mechanism 35) in the mentioned order.

The transfer block 6 is comprised of a thermal press 42 for heating and pressing the print medium C which has been subjected to the overlay process, and a cooling fan 43 for cooling the print medium C which has been heated. Further, the thermal press 42 is comprised of a press table 44 for receiving the print medium C thereon, a presser plate 45 opposed in parallel to the press table 44, and a lift mechanism, not shown, for lifting and lowering the presser plate 45 with respect to the press table 44.

The press table 44 has a heater 46 incorporated therein, and a press-receiving surface 44a formed in parallel with the print medium C and having a larger area than that of the print medium C. The print medium C which has been subjected to the overlay process is placed on the press table 44, in a horizontal position. The presser plate 45 has a heater 47 incorporated therein similarly to the press table 44, and a press surface 45a opposed in parallel to the press-receiving surface 44a. The lift mechanism is comprised of a linkage, such as a cam mechanism and a toggling mechanism. The lift mechanism moves the presser plate 45 downward to the press table 44 to thereby press the press surface 45a against the press-receiving surface 44a. It is preferred that the heaters 46, 47 are each formed by a far infrared heater.

The print medium C, the transfer film F and the cushion sheet S placed on the press table 44 in a horizontal position are pressed against the press table 44 by the presser plate 45 moved downward by the lift mechanism, and heated by the heaters 46, 47, in a state in contact with each other. The thermal pressing process carried out by the thermal press 42 causes the sublimable dye ink held in the transfer film F to be transferred to the print medium C, whereby the image is transferred to the print medium C and formed on the same. In the thermal press 42, the heating operations of the heaters 46, 47 and the pressing operation of the presser plate 45 are controlled individually by the controller 7 (as described in detail hereinafter).

The cooling fan 43 is arranged in a manner facing toward the thermal press 42, and properly sends cooling air to the same, under the control of the controller 7. More specifically, the cooling fan 43 faces toward a gap between the presser plate 45 and the press table 44 and forcibly cools the heated print medium C by the cooling air. As a result, the print medium C on which the image has been transferred by heating is cooled to a temperature low enough for a user to hold by hand.

It is preferred that medium-reversing means 8 is arranged in a manner facing toward the transfer block 6. The medium-reversing means 8, not shown in a specifically detailed manner, is formed by a catcher which can receive and pass the overlaid body of the medium and film (print medium C), and is capable of turning over the print medium C having an image transferred thereto, as required, and then setting the same again in the thermal press 42. This makes it possible to continuously transfer and form printed images on both sides of the print medium C, and even if the print medium C undergoes warpage due to a first operation of heating under pressure, it can be restored to its flat state by performing another operation of the same under the same conditions.

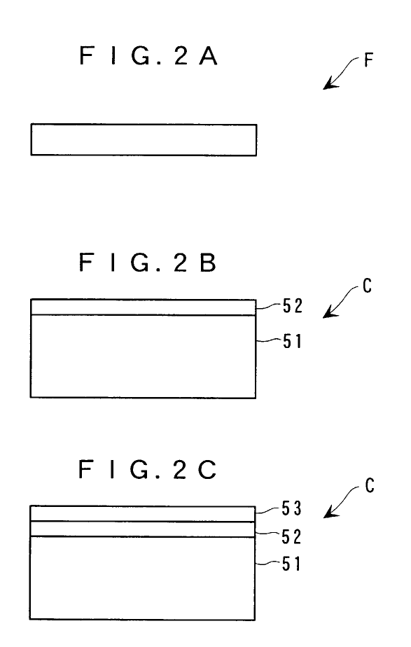

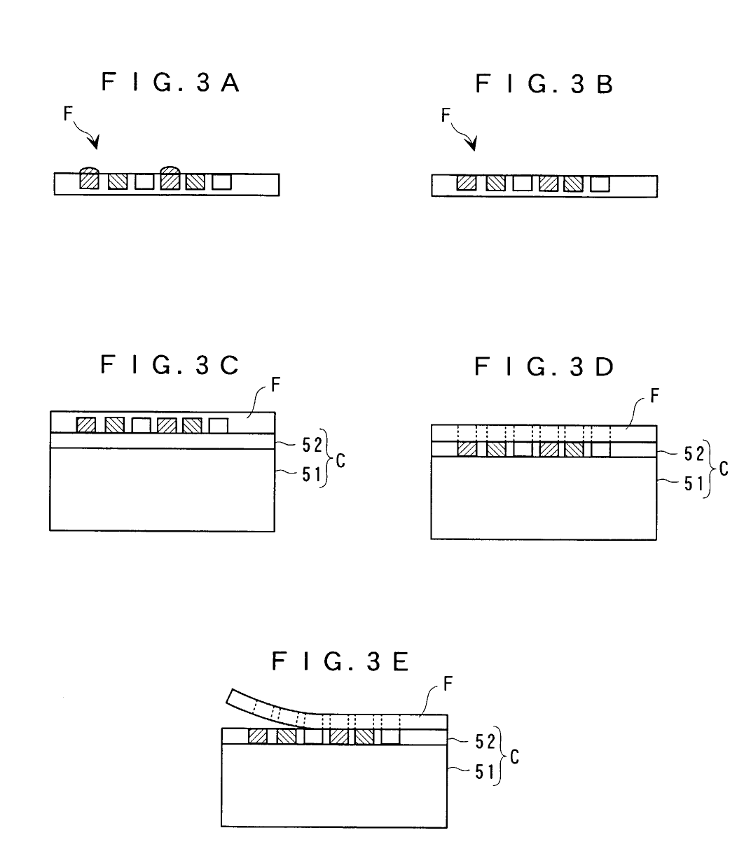

Now, before describing details of the control process for controlling the operation of the printer block 4 and the transfer block 6, the transfer film F and the print medium C as well as an image-forming process using the transfer film F and the print medium C will be described in more detail. FIG. 2A is a cross-sectional view of a structure of a transfer film for use in the FIG. 1 image-forming apparatus; FIG. 2B is a cross-sectional view of a structure of an inexpensive print medium for use in the FIG. 1 image-forming apparatus; and FIG. 2C is a cross-sectional view of a structure of a high-grade print medium for use in the FIG. 1 image-forming apparatus. FIGS. 3A to 3E are cross-sectional views of the transfer film and a print medium, schematically illustrating a procedure of printing an image on the transfer film and transferring the image from the transfer film to the print medium to form the image on the print medium.

The transfer film F is a so-called image-receiving sheet which is formed of a heat-resistant and water-soluble resin material composed of a principal component of PVA (polyvinyl alcohol) or pyrrolidone as a single layer as shown in FIG. 2A. The transfer film F receives the sublimable dye ink directly ejected thereon in a substantially upper half area thereof in the direction of thickness, and is capable of temporarily holding the same. In the present embodiment, since the transfer film F is formed of a water-soluble resin, it is possible to maintain excellent ink absorbency for absorbing the sublimable dye ink in the printing process, which allows the sublimable dye ink to be stably impregnated into the transfer film F and held in the same without being diffused.

Further, the transfer film F is composed of not only PVA as the principal component but also the additives of a material which exhibits slight tackiness when pressed and heated, and a material which exhibits a slightly curable property when exposed to the air after having been pressed and heated. Therefore, the heat from the thermal press 42 causes the transfer film F to exhibit the weak tackiness of the first-mentioned material and firmly stick to the print medium C, while the air from the cooling fan 43 causes the transfer film F to exhibit the slight curability of the second-mentioned material, thereby making the same easy to separate from the print medium C.

Further, the transfer film F is configured such that the printing surface via which the sublimable dye ink is received is smooth, and the whole of the transfer film F is soft, so as to enable the transfer film F to be brought into proper intimate contact with the print medium C. Therefore, when the transfer film F and the print medium C are overlaid to each other and pressed, air and bubbles trapped between the contact surfaces of the transfer film F and the print medium C are expelled to bring the two into intimate contact with each other. However, the transfer film F may be of hard resin, depending on the kind of the print medium C and the like.

On the other hand, FIGS. 2B and 2C show the laminate structures of the two kinds of print media C provided in the present embodiment. The print medium C shown in FIG. 2B is comprised of a substrate layer 51 and an ink-fixing layer 52 laminated on a surface of the substrate layer 51, while the print medium C shown in FIG. 2C further has a fluorine film layer 53 laminated on a surface of the ink-fixing layer 52, instead of a laminating film being laminated thereto. The print media may be roll paper, printing tape or cutsheet paper, but in the present embodiment, description will be given by taking a card as an example of the print medium.

The substrate layer 51 of each of the print media (card) C is formed of a plastic film e.g. of PVC (polyvinyl chloride) or PET (polyethylene terephthalate), or a synthetic paper so as to maintain the rigidity of the entire print media C. Further, in general, the substrate layer 51 is formed of a basically white-colored material. The ink-fixing layer 52 is formed e.g. of a transparent PET film and serves as a layer which is finally impregnated with sublimable dye ink for printing. In short, an image is thermally transferred into the ink-fixing layer 52 and fixed therein. It is preferred that the surface of the print medium C, i.e. the surface of the ink-fixing layer 52 which faces the printing surface of the transfer film F should be also configured to be smooth.

As shown in FIG. 3A, when the image is printed on the transfer film F by the ink jet printing method, ink droplets of the sublimable dye ink are impregnated into the transfer film F and held in the same. At this time point, the ink droplets are held in the substantially upper half of the transfer film F without being diffused into the periphery of the same. The amount of moisture of ink per unit area depends on the printed image, and therefore, the transfer film in a humid state is dried by blowing hot air thereto to remove the moisture of the ink therefrom (FIG. 3B). This makes it possible to reduce the amount of moisture vaporized in the following thermal pressing process to a desired very small extent to suppress generation of vapor bubbles.

Then, the transfer film F is turned upside down and overlaid to the print medium C such that the printing surface of the transfer film F faces the print medium C (FIG. 3C). At this time, it is preferred that air or bubbles are completely expelled from the interface or between the contact surfaces of the transfer film F and the print medium C overlaid to each other, by causing the roller to be relatively rolled on the non-printing surface of the transfer film F.

When the print medium C overlaid with the transfer film F is heated under pressure contact with the same, more specifically, in a state of the transfer film F and the print medium C being relatively pressed against each other, the ink droplets penetrate up to the proximity of the boundary between the ink-fixing layer 52 and the substrate layer 51 thereunder as migration particles having sizes at a molecular level (FIG. 3D). In other words, when the ink droplets held in the transfer film F are heated, they penetrate into the ink-fixing layer 52 to be evaporated/diffused and develop color in the ink-fixing layer 52, whereby the image is fixed and formed in the ink-fixing layer 52. Thereafter, the transfer film F is separated from the print medium C (FIG. 3E) to expose the ink-fixing layer 52 to the outside, whereby the print medium (card) C having the image thermally transferred into the ink-fixing layer 52 is produced.

The transfer film F separated from the print medium C is caused to exhibit its water-soluble property by immersion in water so as to be dissolved. As a result, it is possible to completely destroy the original image faintly left on the transfer film F, so that forgery of the print medium C can be also prevented. Needless to say, the print medium C having the transfer film F laminated thereon may be immersed in water to thereby dissolve the transfer film F alone for removal (separation) of the same from the print medium C.

Similarly, when the FIG. 2C print medium C having the fluorine film layer 53 laminated thereon is used for printing, the heating of the transfer film F causes the ink droplets to pass through the fluorine film layer 53 to be diffused and fixed in the ink-fixing layer 52. In other words, when the transfer film F is removed, the print medium C is produced which has the fluorine film layer 53 as the outermost surface layer thereof for protection of the image transferred into the ink-fixing layer 52. Thus, the print medium C having the image formed thereon is made more excellent in weather resistance, light resistance, heat resistance, rub or abrasion resistance, and chemical resistance by the coating of the fluorine film layer 53. Further, the fluorine film layer 53 gives a high gloss to the print medium C.

It should be noted that the print medium C may have a laminate structure symmetrical with respect to the substrate layer 51 such that thermal image transfer can be effected thereto on both sides thereof. Further, it is preferred that the transfer film F is formed to be slightly larger than the print medium C for easy separation from the same. This makes it possible to provide a peeling margin for the transfer film F as well as to carry out proper image transfer even up to all edges of the print medium C (edge-to-edge printing/transfer). Moreover, since it is possible to fix ink even in the substrate layer 51 depending on the degree of heating, the transparent ink-fixing layer 52 can be dispensed with for reduction of manufacturing costs.

Next, description will be given of control processes executed by the controller 7 for controlling overall operations of the essential blocks of the image-forming apparatus 1, with the principal emphasis on a control process for the printer block 4 and the transfer block 6. The controller 7 is comprised of a CPU for controlling various operations of the image-forming apparatus 1, a ROM for storing control programs and data for controlling the essential blocks, a RAM for use as various work areas for carrying out the respective control processes, and drive circuits for driving the respective essential blocks of the image-forming apparatus 1. The controller 7 controls the essential blocks individually and in a manner correlated with each other, particularly the dryer device 15, the carrier roller means 16 and the thermal press 41, for achieving thermal transfer of a clear image from the transfer film F to the print medium C.

First, the control process of the printer block 4 will be described in detail. The controller 7 causes the printer device 14 to print on the transfer film F based on image information formed by a personal computer (PC) or the like. Further, the controller 7 determines the amount of heat to be generated by the dryer 15 (determined by the heating temperature and heating duration) and the quantity of air as well as the film feeding speed of the carrier roller means 17, by looking up its own condition tables prepared by taking the factor of properties (material quality, type, thickness) of the transfer film F into account, and based on printing information (mainly of an amount of ink) based on which the printer device 14 prints on the transfer film F.

More specifically, the controller 7 starts the dryer device 15 after printing on the transfer film F, and drives the same to perform drying operation with a predetermined amount of heat and/or a predetermined quantity of air, based on the printing information based on which the printing is effected on the transfer film F. At the same time, the controller 7 causes the carrier roller means 16 to advance the transfer film F at a feed speed (film feeding speed) dependent on the predetermined amount of heat and/or the predetermined quantity of air, over a predetermined time period, while exposing the transfer film F to the dryer device 15. When the carrier roller means 16 has sent the transfer film F out to the cutter device 17, the driving of the dryer device 15 is stopped. It should be noted, in this case, that the film feeding speed at which the transfer film F is advanced by the carrier roller means 16 may be made constant, and only the amount of heat and/or the quantity of air may be controlled to simplify the control of the dryer device 15. Further, it is also possible to set the feeding speed to zero, i.e. stop the feeding of the transfer film F, and in this state, the transfer film may be exposed to the dryer device 15.

The printing information is based on a total amount of ink used per unit image (per one printing operation performed on the transfer film F), and details of the information will be described based on examples. When a print image is printed with an enhanced resolution, that is, enhanced by increasing the number of dots printed per unit area either by increasing the number of times of ejection of ink from the ink jet head 25 or by increasing the number of ejection nozzles of the head 25, or when a print image is printed with enhanced reproducibility of intermediate tones of color by multi-value recording in which a plurality of ink droplets are ejected per dot, the amount of heat and/or the quantity of air are/is increased than normal.

Further, when an image is printed by using a composite black formed by mixing three colors (Y, C, M) for the color B of sublimable dye ink, it necessarily increases the amount of ink per unit area (unit ink ejection amount). Therefore, in this case, the drying process by the dryer device 15 is controlled by taking into account print areas printed using the composite black through calculation of the unit ink ejection amount.

Further, when the so-called edge-to-edge printing is performed which is required in the case of the print medium C being a card, a solid fill print is formed which has an increased print area and an increased unit ink ejection amount, and therefore, the drying processing is controlled to an increased amount of heat generation. Thus, the transfer film F in a humid state with the printed image is dried to an adequate extent in advance, and sent to the transfer block 6 in a state with the moisture of ink having been vaporized off.

Next, the control process of the transfer block 6 will be described in detail. The controller 7 controls the heating conditions, etc. of the transfer block 6 by looking up its own condition tables prepared by taking the factors of material quality, etc. of the print medium C into account. More specifically, the controller 7 determines the heating conditions, etc. of the transfer block 6 i.e. heating temperature and pressing force of the thermal press 42 and the driving of the cooling fan 43 as well as timing for starting the operations of the thermal press 42 and the cooling fan 43. Alternatively, the image-forming apparatus 1 may be linked to a personal computer storing attribute information of the transfer film F and the print medium C, so as to allow the heating conditions and the like to be determined based on the information.

Now, description will be given of the control process for the transfer block 6, which is executed based on the determined heating conditions, etc. and the flow of the control process. First, the print medium (overlaid body) C introduced onto the press table 44 of the thermal press 42 after the overlay process is pressed, prior to heating operation, against the press table 44 in a state of the thermal press 42 being driven for pressing operation with its heating operation in an Off state. More specifically, the print medium (overlaid body) C which has been subjected to the overlay process is pressed from the transfer film side via the cushion sheet S by an adjusted pressing force of the presser plate 45 which is moving downward with the heaters 46, 47 being not driven for heating. As a result, air is expelled from the interface between the print medium C and the transfer film F, and the print medium C and the transfer film F are brought into firm and intimate contact with each other. It should be noted that the downward movement speed of the presser plate 45 is preferably progressively reduced when the presser plate 45 reaches a position close to its lower movement end, so as to progressively increase the pressing force to a predetermined pressing force.

Then, the two heaters 46, 47 are started simultaneously and driven for operation at a predetermined heating temperature. In this case, the thermal press 42 stops pressing and starts heating successively. More specifically, in the heat and press treatments carried out sequentially by the thermal press 42, at least the start of heating by the heaters 46, 47 is delayed in timing with respect to the start of pressing by the presser plate 45. Then, the heat and press treatments are carried out over a predetermined time period, whereby the print image printed on the transfer film F is transferred onto the print medium C. It should be noted that the heating temperature is preferably controlled such that it is raised progressively (stepwise or continuously).

Then, the driving of the heaters 46, 47 for heat generation is stopped, and the driving of the cooling fan 43 is started, with the pressure contact state between the print medium C and the thermal press 42 being maintained. As a result, the print medium (overlaid body) C is rapidly cooled in a state sandwiched between the presser plate 45 and the press table 44, whereby warpage, distortion or deformation of the print medium (overlaid body) C which might be caused by heating is prevented. When the print medium (overlaid body) C is cooled down by a certain degree (to a temperature below a softening temperature of the print medium C), the presser plate 45 is moved upward, and then the operations of the thermal press 42 and the cooling fan 43 are stopped. Thus, the thermal pressing process of the transfer block 6 is completed.

It should be note that the print medium C having the image fixed thereon may be again subjected to the heating under pressure and the following cooling under pressure by the thermal press 42 and the cooling fan 43, by using the medium-reversing means 8. Further, when thermal transfer of an image is performed on one side of the print medium C, the heating temperature of the lower heat 46 on a side remote from the transfer film F is preferably controlled to a somewhat lower temperature than the upper heat 47, so as to prevent the deformation of the print medium, such as warpage.

The thermal press 42 may be controlled such that when print images are thermally transferred to both sides of the print medium C, the heater 46 of the press table 44 and the heater 47 of the presser plate 45 are both driven for heat generation under the same conditions, but when an image is thermally transferred only to a front surface of a print medium C, the heater 47 of the presser plate 45 alone may be driven for heat generation.

According to the image-forming apparatus 1 constructed as above, before the thermal pressing process by the thermal press 42, the moisture of ink of a printed image is forcedly vaporized, so that the amount of moisture vaporized in the thermal pressing process is reduced to a very small level to properly suppress generation of vapor bubbles. This prevents the color variation and bleeding. The sequence of control processes of the thermal press 42 make it possible to apply uniform pressure to the whole surfaces of the transfer film F and the print medium C overlaid in intimate surface contact with each other while performing efficient heat treatment thereto, by the thermal press method, so that it is possible to form a clear transfer image with no color irregularity on the transfer surface of the print medium C without forming microscopic asperities on the same. The dryer device 15 may be formed by an irradiation type, such as a halogen lamp, in place of the dryer.

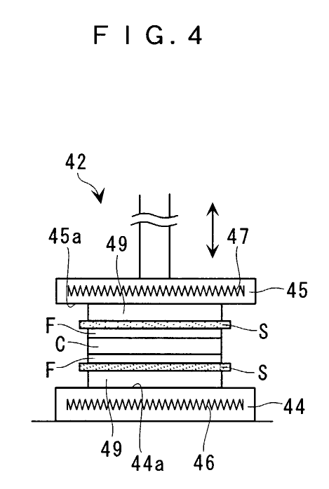

Next, an image-forming apparatus according to a second embodiment of the invention will be described with reference to FIG. 4. In the present embodiment, a print medium C is brought to a thermal press 42 in a state sandwiched between a pair of heat-resistant plates 49, 49 and is heated and pressed via the heat-resistant plates 49, 49. The pair of heat-resistant plates 49, 49 are each formed of a material having high thermal conductivity and diffusivity, such as a metal, a heat-resistant tempered glass, silicone-ceramic, or the like, and each of the heat-resistant plates 49, 49 has a flat plate shape. Further, the pair of heat-resistant plates 49, 49 have cushion sheets S, S laminated on respective surfaces thereof opposed to each other. In short, the print medium C which has been subjected to the overlay process is placed on a press table 44 in a state sandwiched between the pair of heat-resistant plates 49, 49 from both upper and lower sides thereof, and is subjected to the thermal pressing process.

According to this image-forming apparatus, since the pair of heat-resistant plates 49, 49 can prevent warpage of the print medium C due to heat, it is possible to cool the print medium C separately by the cooling fan 43 in an additional manner after the thermal pressing process by the thermal press 42.

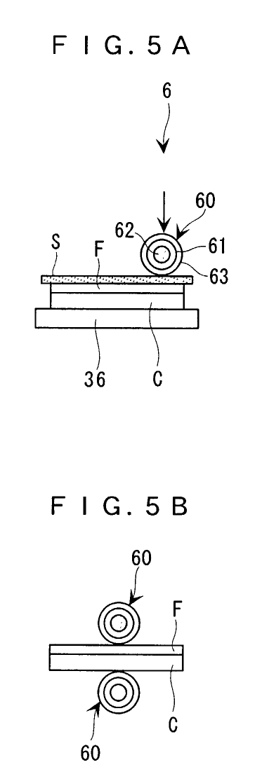

Next, a transfer block of an image-forming apparatus according to a third embodiment of the invention will be described with reference to FIG. 5A. This embodiment is distinguished from the first embodiment in that the transfer block 6 has a heating pressure roller 60 which is brought into relative rolling contact with the print medium C (overlaid body) in place of the thermal press for performing the thermal pressing process. The heating pressure roller 60 is comprised of a roller body 61 in a hollow cylindrical form of stainless steel, a far infrared radiation heater 62 contained as a heat source within the heater body 61, and a rubber roll 63 wound around the outer peripheral surface of the roller body 61.

The far infrared radiation heater 62 is formed by a halogen lamp, and has its heating operation controlled by the controller 7 to keep the heating pressure roller 60 at a raised temperature uniformly along the length thereof. The rubber roll 63 is formed by a heat-resistant silicone rubber and has the heat generated by the far infrared radiation heater 62 transmitted via the roller body 61. The heating pressure roller 60 has a predetermined length corresponding to the print medium C and has its rolling pressure controlled by the controller 7.

More specifically, as shown in FIG. 5A, the overlaid body (C) formed by the overlay block 5 is conveyed on the table 36 to the transfer block 6, and the heating pressure roller 60 opposed to the overlaid body set on the table 36 is brought into relative rolling contact with the overlaid body from above (from the cushion sheet S side). The heating pressure roller 60 performs the thermal pressing process on the transfer film F and the print medium C according to a control procedure similar to that of the thermal press 42, thereby thermally transferring an image printed on the transfer film F to the surface of the print medium C. In this case, since the heating pressure roller 60 performs the sequence of thermal pressing operations, it is possible to press and heat uniformly over the whole surface of the overlaid body (C).

More specifically, the heating pressure roller 60 sequentially presses out air from between the transfer film F and the print medium C to continuously bring the transfer film F and the print medium C into partial intimate contact with each other. This can bring the transfer film F and the print medium C into intimate contact under pressure without forming microgaps. As a result, it is possible to obtain a high-quality transfer image and at the same time perform the thermal pressing process continuously to shorten the processing time.

FIG. 5B shows a variation of the third embodiment in which a pair of heating pressure rollers 60 are provided (cushion sheet S is omitted in this figure) whereby the thermal pressing process by the transfer block 6 is performed by feeding the transfer film F and the print medium C between the heating pressure rollers 60 which relatively roll thereon while sandwiching the same. This makes it possible to perform the thermal pressing process continuously and thereby enhancing time efficiency. It should be noted that the pair of heating pressure rollers 60, 60 can be individually controlled as to the temperature of heat generated thereby, so as to prevent the warpage of the print medium C having the image transferred thereto.

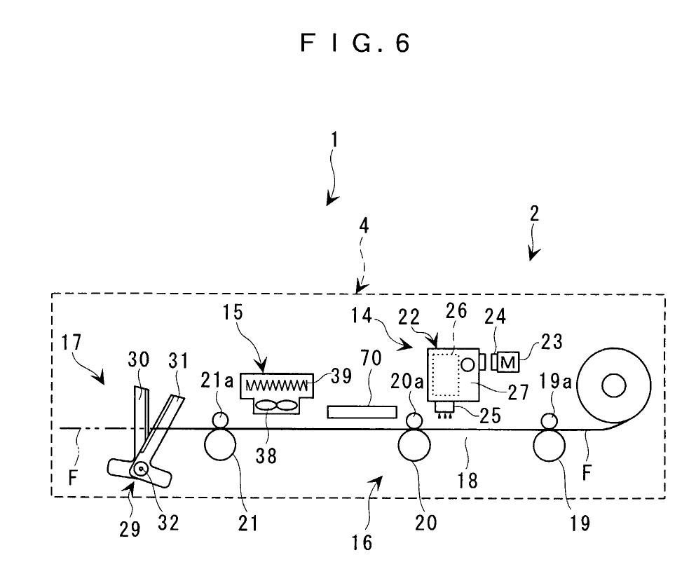

Next, a printer block of an image-forming apparatus according to a fourth embodiment will be described with reference to FIG. 6. This embodiment is distinguished from the first embodiment in that a preheating plate 70 is arranged on the transport passage 18 at a location between the printer device 14 and the dryer device 15, for preheating the transfer film F at a relatively low temperature in a non-contacting manner. The preheating plate 70 is formed by a plate-shaped far infrared radiation heater having a predetermined heating area, and arranged along the transport passage 18 (and hence the transfer film F) at a location downstream of the printer device 14 and upstream of the dryer device 15. The preheating plate 70 faces the printing surface of the transfer film F having an image printed thereon, and being advanced by the intermediate feed roller 20, and preheats the transfer film F, prior to the drying process by the dryer device 15.

This brings the printed transfer film F which is humid to the dryer device 15 in a state warmed by the preheating, so that the dryer device 15 can finish the main drying process in a reduced time. Further, since the preheating plate 70 is inserted between the printer device 14 and the dryer device 18, these devices are spaced from each other by a predetermined distance, whereby it is possible to conveniently prevent the air blown by the fan 38 from directly affecting the ink jet head 25 of the printer device 14. It should be noted that a partition wall may be provided between the printer device 14 and the dryer device 15 (or the preheating plate 70) to prevent the printing and the drying including the preheating from affecting each other.

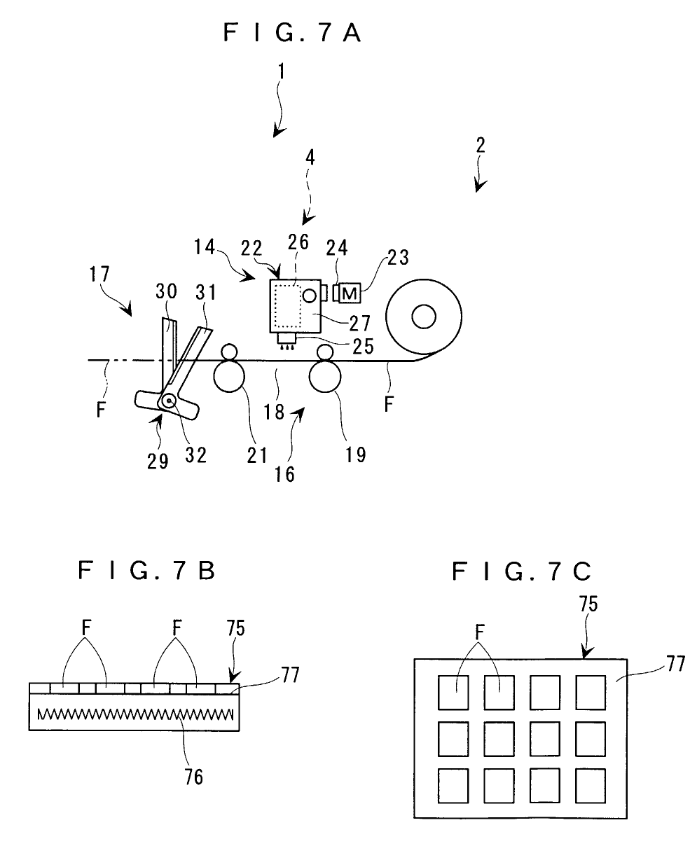

Next, a printer block of an image-forming apparatus according to a fifth embodiment of the invention will be described with reference to FIGS. 7A to 7C. In the printer block 4 of this embodiment, after printing on a transfer film F and cutting off the same, the cut-off strip of the transfer film F is brought to the dryer device 15 (in FIG. 7A, the dryer device 15 is omitted). As shown in FIGS. 7B and 7C, the dryer device 15 is formed by a heat plate 15 on which the cut-off strip of transfer film F is placed, differently from the dryer type employed in the preceding embodiments. The heat plate 75 contains a nichrome wire heater 76 and has a placing surface 77 on which a plurality of strips of transfer film F can be horizontally placed. The amount of heat generated thereby is controlled by controlling the quantity of heat determined by a heating temperature and a heating duration. The heat plate 75 performs the drying process by heating the transfer film F having an image printed thereon and placed on the placing surface 77 such that the non-printing surface of the film F being supported by the placing surface 77.

According to this embodiment, the control of the dryer device 15 is simplified to thereby vaporize the moisture of ink forming the image printed on the transfer film F. Further, it is possible to perform a batch process with enhanced time efficiency, by collectively placing a plurality of printed strips of transfer film F on the dryer device.

It is further understood by those skilled in the art that the foregoing are preferred embodiments of the invention, and that various changes and modifications may be made without departing from the spirit and scope thereof.

What is claimed is:

1. An image-forming apparatus comprising:
printing means for printing an image on a transfer film, with a sublimable dye ink, by an ink jet printing method;
drying means for vaporizing moisture of the sublimable dye ink of a printed image formed on the transfer film; and
fixing means for overlaying the dried transfer film and a print medium with each other, and carrying out a thermal pressing process on the dried transfer film and the print medium overlaid with each other, to thereby diffuse and fix the sublimable dye ink held in the transfer film on a surface of the print medium.

2. An image-forming apparatus according to claim 1, wherein said drying means comprises a heater for heating air into hot air, and a fan for blowing the hot air toward the transfer film.

3. An image-forming apparatus according to claim 2, including a transport passage for feeding the transfer film thereon, said printing means and said drying means facing said transport passage, and
a preheating plate arranged to face said transport passage at an intermediate location along said transport passage between said printing means and said drying means, for preheating the printed transfer film.

4. An image-forming apparatus according to claim 2, including control means for controlling operation of said drying means, and
wherein said control means controls at least one of an amount of heat generated by said drying means and a quantity of the hot air blown by said drying means, based on an amount of ink for forming the printed image.

5. An image-forming apparatus according to claim 2, including film-feeding means for feeding the transfer film to bring the transfer film to said drying means, and
control means for controlling operation of said film-feeding means,
wherein said control means controls a feeding speed at which said film-feeding means feeds the transfer film, based on an amount of ink for forming the printed image.

6. An image-forming apparatus according to claim 1, wherein said drying means comprises a heat plate for heating the transfer film placed horizontally thereon.

7. An image-forming apparatus according to claim 6, including control means for controlling operation of said drying means,
wherein said control means controls an amount of heat generated by said drying means, based on an amount of ink for forming the printed image.

8. An image-forming apparatus according to claim 1, further including medium-reversing means for turning over the print medium on which the image has been fixed, and setting the print medium again on said fixing means.

9. An image-forming apparatus according to claim 1, wherein the print medium is a card.

10. An image-forming apparatus according to claim 1, wherein the transfer film has a flat surface formed of a water-soluble resin material, via which the transfer film is overlaid to the print medium.

11. An image-forming method comprising the steps of:
printing an image on a transfer film, with a sublimable dye ink, by an ink jet printing method;
vaporizing moisture of the sublimable dye ink of a printed image formed on the transfer film; and
overlaying the dried transfer film and a print medium with each other, and carrying out a thermal pressing process on the dried transfer film and the print medium overlaid with each other, to thereby diffuse and fix the sublimable dye ink held in the transfer film on a surface of the print medium.
